(19) United States
(12) Patent Application Publication
(10) Pub. No.: US 2012/0116972 A1
(43) Pub. Date: May 10, 2012

(54) Electronic Payment Orders

(75) Inventor: David Walker, Waxahachie, TX (US)

(73) Assignee: Electronic Check Clearing House Organization

(21) Appl. No.: 12/943,611

(22) Filed: Nov. 10, 2010

(51) Int. Cl. G06Q 20/00

(52) U.S. Cl. 705/44

(57) ABSTRACT

Methods, systems, and apparatus, including computer programs encoded on a computer storage medium, for generating and clearing electronic payment orders. In one aspect, a method includes generating an electronic payment order using a computer. Signature data authorizing the electronic payment order is electronically captured. The signature data includes a stroke pattern of a user signature and is captured substantially concurrently with generating the electronic payment order. The electronic payment order and the electronically captured signature are transmitted to an entity authorized to receive payment based on the electronic payment order.

### BACKGROUND

This specification relates to electronic payment orders for authorizing and instructing the payment from a payor to a payee without the use of paper checks.

Existing payment systems include both paper-based payments and partially or fully electronic-based payments. Generally, paper-based payments include checks in which a payor provides a signed handwritten or printed check to a payee. The check includes information such as the payee's identity, the amount of the payment, the identity of the paying bank, the payor's account information, and the payor's signature. Such checks can be cleared by depositing the paper check at the payee's bank (or endorsing the check over to some other entity) and clearing the check in paper form through the payment system (e.g., through one or more intermediary institutions including the Federal Reserve and/or clearing houses). In recent years, truncation of paper checks has become common. Check truncation involves converting a paper check into electronic form, either by capturing an image of the check or by converting the check into some other type of electronic payment (e.g., an automated clearing house (ACH) payment). Other types of electronic payments that do not involve the use of paper checks also exist. For example, ACH payments can be initiated for some types of transactions without a paper check and credit card and debit card transactions can be initiated by electronically reading information from a physical card or using a credit card number. Various regulations and statutory rules apply to the creation and processing of payment transactions depending on the type of transaction, the participants in the transaction, and the way in which the transaction is initiated, authorized (if applicable) and cleared/settled.

### SUMMARY

This specification describes technologies relating to initiating, authorizing and clearing and settling electronic payment orders without the use of a paper check. An electronic payment order, as further described herein, can be an electronic authorization for payment (e.g., that allows the payee to demand payment on the item, similar to a conventional check) that contains both an image record showing the payment instruction information, as well as other electronic payment instruction information (e.g., data defining routing number, account number, etc.), that is created electronically without the use of a paper check to create the image record. For example, an electronic payment order can be an electronic record that: (a) has all informational and other elements (dollar amount, payee name, payor name) typically contained in a paper “negotiable instrument” under Article 3 of the Uniform Commercial Code, (b) is created and exists only as an electronic record, and is not created by scanning or imaging a paper check; (c) meets the applicable industry standards and guidelines for an image of a physical paper check, except that image in the electronic record was not created by scanning or imaging a paper check; and/or (d) contains MICR line characters on the front of the image (without the use of magnetic ink because the image is electronic) that can be used for, e.g., optical character recognition.

In general, one innovative aspect of the subject matter described in this specification can be embodied in methods that include the actions of generating (e.g., by operation of a computer) an electronic payment order, electronically capturing signature data authorizing the electronic payment order, and transmitting the electronic payment order and the electronically captured signature to an entity authorized to receive payment based on the electronic payment order. The signature data includes a stroke pattern of a user signature and is captured substantially concurrently with generating the electronic payment order. Other embodiments of this aspect include corresponding systems, apparatus, and computer programs configured to perform the actions of the methods, encoded on computer storage devices.

These and other embodiments can each optionally include one or more of the following features. The electronic payment order is generated on a mobile device by a user and the stroke pattern is electronically captured using a touch screen or a digital pad that detects contact with a pad surface. The electronic payment order is generated using one of an application stored on the mobile device or an electronic document retrieved from a web server. The mobile device is authenticated based on a prior registration of the mobile device with a server, and the user is authenticated based on credentials provided by the user. It is confirmed that the user has agreed to terms and conditions associated with a service that allows the user to generate electronic payment orders and that a payee identified in the electronic payment order has agreed to terms and conditions associated with a service that allows the payee to receive electronic payment orders from the payor and deposit electronic payment orders with the payee bank for processing and collection. A notice of the generation of the electronic payment order is transmitted to a financial institution having a payor account on which the electronic payment order is drawn. A request to approve payment of the electronic payment order is generated in response to the notice and is received at an electronic device associated with the payor. The request to approve payment further includes a request to approve a charge for insufficient funds in the payor account for payment of the electronic payment order. The electronically captured signature data is encrypted. The signature data includes at least one of pressure data or stroke speed data. Generation of the electronic payment order is initiated by a payor having a payor account with a first financial institution, the electronic payment order is drawn on the payor account, and the electronic payment order includes an order to pay specified funds to a payee. The electronic payment order is sent through a check image exchange channel from a second financial institution authorized to collect the funds on behalf of the payee. Agreements that the electronic payment order is to be treated as a negotiable instrument are in place between the payor and the first financial institution, the first financial institution and the second financial institution, and the payee and the second financial institution. The electronic payment order includes data distinguishing the electronic payment order from a check image at least when (and if) the electronic payment order is sent through the check image exchange channel. The check image exchange channel is used to exchange images that can be printed to produce substitute checks compliant with the Check Clearing for the 21st Century Act, and the electronic payment order is not eligible to be printed as a substitute check. The check image exchange channel includes one or more computers associated with the second financial institution adapted to send electronic files including check images to at least one of an intermediary or the first financial institution across a network, and one or more computers associated with the first financial institution adapted to receive electronic files including check images from at least one of an intermediary or the second financial institution across a network. Authentication data associated with hardware of the mobile device is sent to a server, credentials are received from a user prior to generating the electronic payment order, and the user is authenticated based on the credentials provided by the user or the credentials sent to the server. A request to authenticate the electronic payment order is sent to a server, and the request to authenticate includes at least one of a password associated with the user or predetermined authentication information associated with the data processing apparatus. The electronic payment order is generated in response to a request received from a particular user, and the signature data is compared to other signature data corresponding to one or more user signatures of the particular user provided on other electronic payment orders. The user signature is authenticated based on a result of the comparison between the signature data and the other signature data.

In general, another aspect of the subject matter described in this specification can be embodied in systems that include one or more storage devices storing signature data from electronic signatures applied to electronic payment orders, and one or more processors. The processors are operable to receive signature data from an electronic signature applied by a user to a particular electronic payment order to authorize payment of the particular electronic payment order from a particular payor account. The particular electronic payment order is generated on a mobile device and is electronically captured, and the signature data includes a stroke pattern for the electronic signature captured substantially concurrently with generating the particular electronic payment order. The processors are also operable to store the received signature data in the one or more storage devices and compare the received signature data to signature data previously stored in the one or more storage devices to authenticate the received signature data.

These and other embodiments can each optionally include one or more of the following features. The system further includes one or more servers for a payor institution that maintains the payor account, wherein the one or more servers are operable to receive the particular electronic payment order from at least one of a mobile device on which the particular electronic payment order is generated or a payee institution authorized to collect funds based on the electronic payment order. The processors are operable to determine whether to authorize payment of the funds based on the comparison of the received signature data to the previously stored signature data. The one or more servers are operable to receive, from payee institutions, electronic payment orders transmitted across a check image exchange channel used to exchange images that can be printed to produce substitute checks compliant with the Check Clearing for the 21st Century Act, and the electronic payment order is not eligible to be printed as a substitute check. The electronic payment order includes data distinguishing the electronic payment order from a check image. The one or more servers are further operable to authenticate the mobile device based on a prior registration of the mobile device with the one or more processors and authenticate the user based on credentials provided by the user. The one or more processors are further operable to transmit a request to approve a charge for insufficient funds in the payor account for payment of the particular electronic payment order. The one or more processors are operable to confirm that the user has agreed to terms and conditions associated with a service that allows the user to generate electronic payment orders and confirm that a payee identified in the electronic payment order has agreed to terms and conditions associated with a service that allows the payee to receive electronic payment orders. The signature data includes at least one of pressure data or stroke speed data.

Particular embodiments of the subject matter described in this specification can be implemented so as to realize one or more of the following advantages. Payments can be initiated and cleared electronically without ever needing to create, transport, or handle a paper check, thereby avoiding the associated costs and processing time. Moreover, payments can be initiated and cleared without restricting the speed of collection, while maintaining detailed payment information (e.g., all the information typically on a check, including a human-readable signature). Electronic payment orders can be generated on mobile devices and sent electronically directly to a payee. Unique information relating to an individual's signature (e.g., stroke pattern, pressure, speed, etc.) can be captured, stored, and compared over time to automatically determine whether a signature applied to a particular payment order is likely to be valid. Furthermore, other authentication techniques can also be applied (e.g., requiring user ID and password logins to generate and/or receive an electronic payment order, and requiring that electronic payment orders be generated and/or received only on preauthorized devices associated with a particular account) to ensure that an electronic payment order is valid. In at least some cases, the validity of an electronic payment order, the account on which it is drawn, and/or the electronic signature can be confirmed by the recipient payee virtually in real time. Electronic payment orders can be generated and cleared using a system of agreements among banks that permit their customers to send and receive electronic payment orders and between such banks and their customers, without requiring changes to existing laws or regulations and without requiring a new legal framework. If, however, there is a change in Regulation CC to establish electronic payment orders, a system of agreements may not be necessary. In addition, electronic payment orders can be cleared using existing image exchange networks without requiring that the electronic payment orders be capable of being printed to generate substitute checks that comply with the Check Clearing for the 21^{st} Century Act (Check 21). Notification of electronic payment orders can also be used to provide a retail positive pay service, in which a bank customer can authorize an electronic payment order, authorize an insufficient funds fee (e.g., overdraft penalty fees or overdraft protection fees) in the event that the account is overdrawn, and/or be given notice of an impending overdrawn state if an electronic payment order clears to give the customer an opportunity to deposit or transfer sufficient funds. Use of electronic payment orders also avoids use of paper and thus provides an environmentally friendly (or “green”) payment mechanism. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an architectural diagram of a system for creating and clearing electronic payment orders.

FIG. 2 is a functional block diagram of a system for clearing electronic payment orders.

FIG. 3 is an example of the appearance of an electronic payment order.

FIG. 4 is a flow diagram of a process for generating and clearing an electronic payment order.

Like reference numbers and designations in the various drawings indicate like elements.

### DETAILED DESCRIPTION

The ability to make payments using electronic payment orders can be offered by financial institutions that agree to a set of rules with other financial institutions that offer electronic payment orders and that obtain agreement to the set of rules and legal terms with bank customers to govern the rights of the parties to the payment. Such electronic payment orders can be generated, for example, using a specialized application on a mobile device or a web-based application accessible through a web site and immediately transmitted to a payee electronically. An electronic signature can be applied to the electronic payment order using a touch screen or some type of signature pad, and the electronic signature can accompany the electronic payment order throughout the clearing process for use in assessing the validity of the electronic payment order. The electronic signature can be compared, at various times during the process, against prior electronic signatures of the payor. Payment based on the electronic payment order can be effected virtually immediately or within a very short period of time, by posting a debit in the payor's account at the paying institution and posting a credit in the payee's account at the collecting institution.

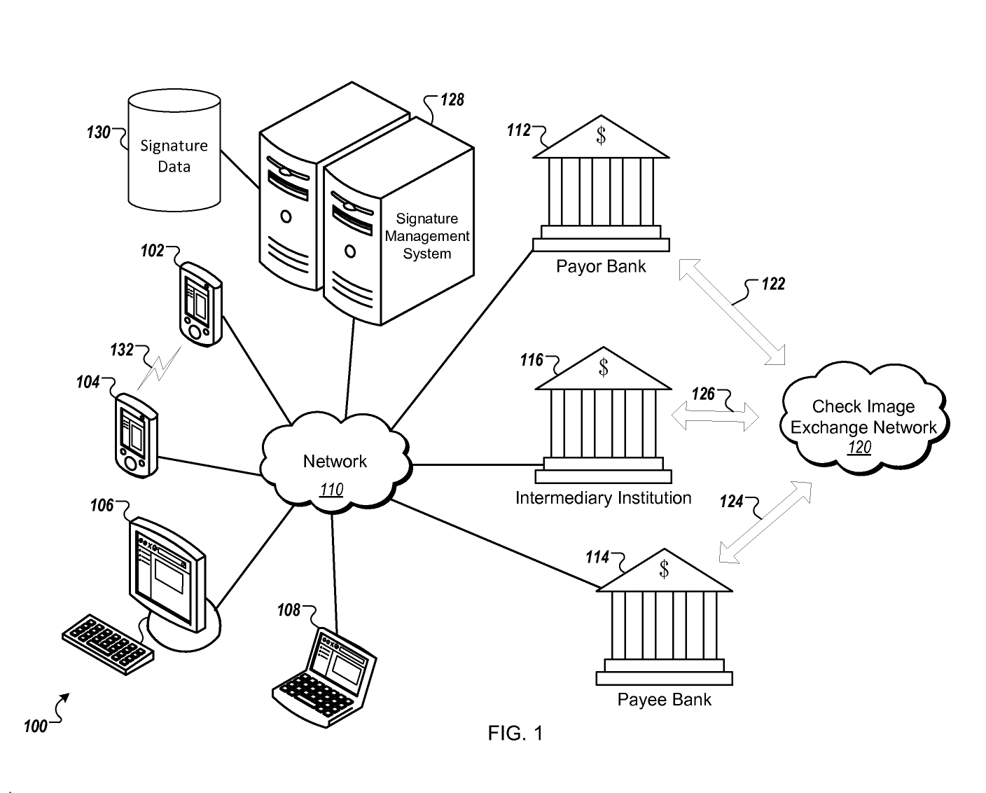

FIG. 1 is an architectural diagram of a system 100 for creating and clearing electronic payment orders. The system 100 includes a payor device 102 and a payee device 104. Each device 102 and 104 can be a mobile device (e.g., a mobile phone, a smart phone, a personal digital assistant, or a tablet computer) and can be used to create, send, and/or receive an electronic payment order. For example, an electronic payment order can be generated on a payor device 102 and sent to a payee device 104 through a network 110 (e.g., as an email attachment) or across a short-range wireless (or wired) communication channel 132 (e.g., using a Bluetooth or infrared connection). In some embodiments, the electronic payment order does not necessarily need to be sent to a payee device 104 but can be sent, for example, to an electronic address associated with the payee (e.g., an email address associated with a server that stores the payee's emails or an Internet protocol (IP) address used for depositing payments to the payee's account) from which the payee may or may not retrieve the electronic payment order to a payee device 104. Electronic payment orders can also be generated and/or received on other types of computing devices associated with the payor, the payee, or some other individual or entity that participates in the payment process, including desktop computers 106 or laptop computers 108. The devices 102, 104, 106, and/or 108 can communicate with one or more of the payor's bank 112, the payee's bank 114, or one or more intermediary institutions 116 using the network 110. The network 110 can include a wireless network (e.g., a cellular network, a Bluetooth network, a Wi-Fi network, a Wi-Max network, or a satellite network), a local area network, the Internet or other wide area network, another type of telecommunications network, any other type of network capable of communicating data, or a combination of two or more of these. The banks or other financial institutions can further communicate across a check image exchange network 120, which may be implemented using portions of the network 110, which may be a separate network, and/or which may include affiliations or other relationships between institutions 112, 114, and/or 116. The system 100 also includes a signature management system 128 that stores signature data in a database 130.

Generally, an electronic payment order directs the payor's financial institution to pay a specified sum to the payee. An electronic payment order can be an electronic record of what may appear to be a check image but which is created without use of an actual paper check. Otherwise, the electronic payment order may include all informational content and other elements necessary to qualify as a negotiable instrument under the Uniform Commercial Code (UCC). As with a conventional check, however, the payee will often endorse over the right to collect on the electronic payment order to the payee's financial institution or to some other entity. The electronic payment order can be signed by the payor using a touch screen of the payor device 102 or another type of digital pad capable of detecting contact with the surface of the digital pad that is connected to the payor device 102 or otherwise capable of communicating with the payor device 102. The electronic signature or data representing the electronic signature can include a stroke pattern, a stroke speed, pressure data, and/or other data that may be unique to the payor's signature. The data can include information sufficient to recreate a relatively complete payor signature or can include selected portions of the electronic signature (e.g., a digital fingerprint). The signature can be applied, for example, using a fingertip, a stylus, or some other device. The payor's electronic signature can be included as part of the electronic payment order. In some cases, the electronic signature can be encrypted, e.g., using a public or a private key associated with the payor or the payor device 102, to prevent others from copying the electronic signature or extracting the data representing the electronic signature. The payee can similarly apply an electronic signature to the electronic payment order to endorse the electronic payment order over to the payee's financial institution or some other entity. Thus, the signatures and endorsements included in the electronic record that defines the electronic payment order are only in electronic form.

Typically, after a payor creates an electronic payment order and sends the electronic payment order to a payee, the payee deposits the electronic payment order with the payee bank 114 (e.g., for posting a credit to the payee's account at the payee bank). The deposit can serve as a de facto endorsement or the payee can separately provide or apply an endorsement over to the payee bank 114. Alternatively, the payee can endorse the electronic payment order over to some other individual or entity. In either case, the endorsement serves to transfer the right to collect funds on the electronic payment order to the endorsee. In addition to sending the electronic payment order to the payee, the payor device 102 can also send a copy of the electronic payment order (e.g., a non-negotiable copy) or data identifying the electronic payment order to the payor bank 112 to provide advance notice of the electronic payment order, to notify the payor bank 112 that the electronic payment order is valid, and/or to enable the payor bank 112 to confirm that sufficient funds are available in the payor's account. The communication with the payor bank 112 can occur just before, concurrently with, or after sending the electronic payment order to the payee.

The payee bank 114 can use the check image exchange network 120 to clear the electronic payment order with the payor bank 112 or an intermediary institution 116, as indicated at 122, 124, and 126. In some embodiments, each of the payor bank 112, the payee bank 114, and the intermediary institution 116 can be a member of one or more check image exchange networks 120 and can communicate with such check image exchange networks as indicated at 122, 124, and 126. Depending on the nature of the memberships and agreements between institutions and the preferred clearing paths of those institutions, however, electronic payment orders may be cleared through different paths depending on the particular institutions involved in clearing the transaction. In some cases, for example, the payee bank 114 may send the electronic payment order to an intermediary institution 116, which then collects funds on the electronic payment order from the payor bank 112.

The signature management system 128 can be used to store electronic signature data that is applied to electronic payment orders. In particular, the signature management system 128 can store electronic signature data in the signature database 130. The signature management system 128 can be associated with one or more of the banks or other financial institutions 112, 114, and 116 or can be maintained by a third party service provider. Signature data can be sent to the signature management system 128 for storage at virtually any point in the clearing process. For example, in some embodiments, the electronic signature data can be sent to the signature management system 128 by the payor device 102 at about the same time that the electronic payment order is created. In other embodiments, the electronic signature data can be sent to the signature management system 128 by the payee bank 114 after it receives the electronic payment order, by the intermediary institution 116 after it receives the electronic payment order, or by the payor bank 112 either after it receives initial notice of (or a copy of) the electronic payment order or after it receives the electronic payment order at the back end of the clearing process (e.g., through check image exchange network 120).

Similarly, the signature data can be sent to the signature management system 128 to confirm the validity of the signature at virtually any point in the clearing process. For example, the signature data can be sent to the signature management system 128 by the payor device 102, the payee device 104, the payee bank 114, an intermediary institution 116, or the payor bank so that the signature data can be compared against prior electronic signatures associated with the account on which the electronic payment order is drawn. For example, statistical variations in the signature stroke pattern, stroke speed, and/or pressure between different signatures can be analyzed by data processing apparatus in the signature management system 128 to automatically determine whether the electronic signature is likely to be a valid signature (e.g., whether the variations fall within an acceptable range). Depending on the certainty of validity, the electronic payment order can either be approved for payment or further clearing, can be denied, or can be flagged for further review. In some embodiments, the electronic signature can be compared against previously stored electronic signature data for the same electronic payment order to ensure that it matches (e.g., to protect against reuse of the same electronic payment order, where a different signature attached to the same electronic payment order may indicate fraudulent activity). In addition, because a human signature is likely to have at least some variation from one writing to another, the electronic signature can be compared against previously stored electronic signature data for other electronic payment orders to ensure that it does not match identically (e.g., which may be indicative of fraudulent capture and reuse of the same electronic signature). In some cases, the signature data is sent to the signature management system 128 both for storage and to confirm the validity of the electronic signature (e.g., against prior electronic signatures by the same payor).

In embodiments where the electronic signature data is encrypted, the signature management system 128 can decrypt the electronic signature data either upon receipt before storing it in the signature database 130 or when needed to perform an authenticating comparison. For example, if the electronic signature data is encrypted using a private key associated with the payor that creates the electronic payment order or the payor device 102, the signature management system 128 can decrypt the electronic signature data using a corresponding public key.

In some embodiments, the system 100 can be used to create electronic payment orders without applying an electronic signature. For example, remotely created electronic payment orders (e.g., payment orders created by a payee, remotely from the payor, with the authorization of the payor, such that the signature of the payor is not included on the remotely created electronic payment order) or corporate electronic payment orders (e.g., payment orders that include a pre-stored signature that is applied to the electronic payment order) may be permitted to be generated (e.g., on desktop computer 106 or laptop computer 108) without applying a dynamically created human signature (i.e., a signature captured as part of or approximately concurrently with generating the electronic payment order, as in the case of an electronic payment order created on a mobile device as described above). Such electronic payment orders can include other security features (e.g., electronic watermarks, encrypted tokens, login authentication, device authentication, etc.) that can be used to confirm their authenticity but can otherwise be transmitted and cleared through the system 100 in the same manner as described above.

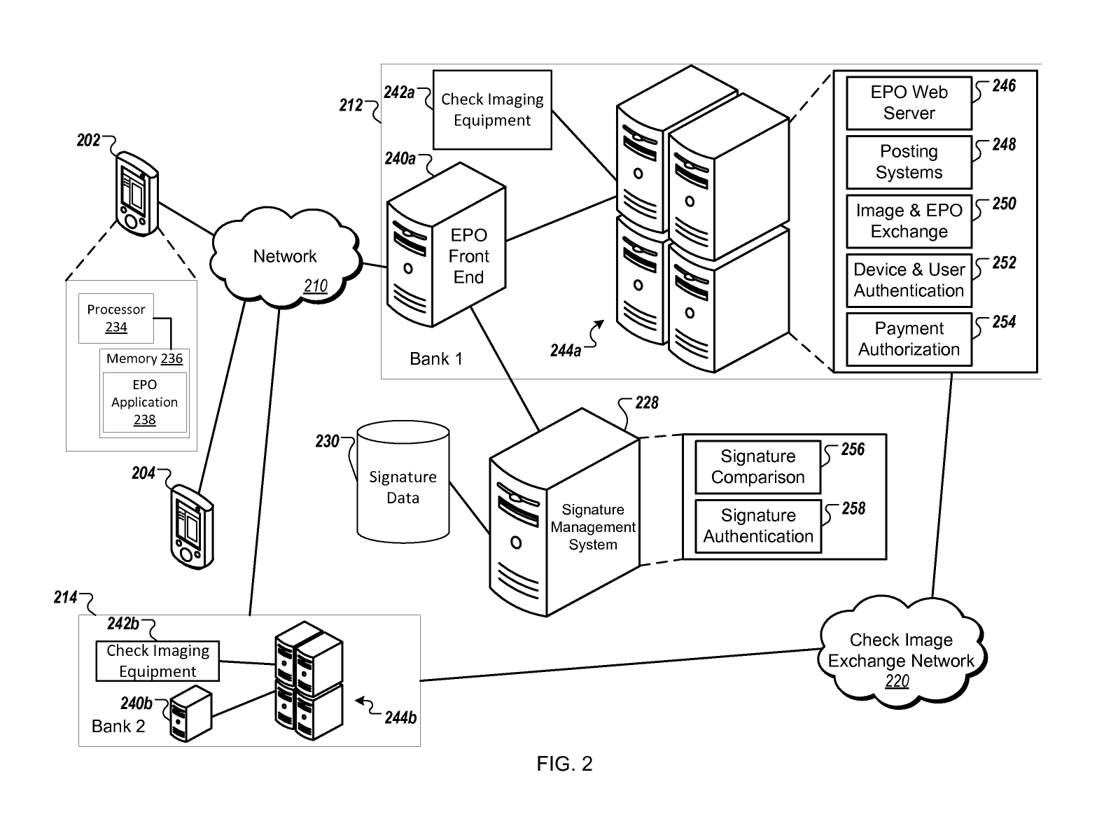

FIG. 2 is a functional block diagram of a system 200 for clearing electronic payment orders. The system 200 is similar to, and includes overlapping features with, the system 100 of FIG. 1, although the system 200 illustrates additional functional characteristics, servers, and software modules relative to the system 100. Features of the systems 100 and 200 can be combined as appropriate to support clearance of electronic payment orders. The system 200 includes mobile devices 202 and 204 (which may correspond, for example, to payor device 102 and payee device 104 of FIG. 1), a first bank 212 (which may correspond, for example, to the payor bank 112 of FIG. 1), and a second bank 214 (which may correspond, for example, to the payee bank 114 of FIG. 1). The system 200 also includes a check image exchange network 220 and a signature management system 228 that further includes a signature database 230. In general, although detailed components are illustrated for only mobile device 202, both of the mobile devices 202 and 204 can include similar features. Similarly, although greater detail is illustrated with respect to the servers and software modules of the first bank 212, the second bank 214 can include similar features. Among other things, the mobile devices 202 and 204 can each be used to generate and receive electronic payment orders, and the first bank 212 and the second bank 214 can each serve as a payor institution or a payee institution depending on whether that bank's customer is the payor or the payee. Thus, although the following discussion focuses on operations of the mobile device 202 and the first bank 212, such operations can also be performed by the mobile device 204 and the second bank 214.

The mobile device 202 includes a processor 234 that is operable to run an application 238 stored in a memory 236. The application 238 can be installed locally and maintained in nonvolatile memory or can be downloaded from a remote server (e.g., as a web page and/or scripts that are executed locally on the device 202). The application 238 can be configured to generate electronic payment orders (EPOs), allow users to apply electronic signatures to the electronic payment orders (e.g., using a touch screen on the device 202 and either authorizing an electronic payment order as the payor or endorsing an electronic payment order as the payee), and transmit generated electronic payment orders to payees and/or collecting or paying financial institutions.

The first bank 212 and the second bank 214 each include an electronic payment order (EPO) front end server 240a and 240b, check imaging equipment 242a and 242b, and one or more servers 244a and 244b. The EPO front end server 240a receives electronic payment orders from mobile devices 202 and 204 either for deposit as the collecting bank or as an advance notice of the electronic payment order as the paying bank. The EPO front end server 240a also communicates with the one or more servers 244a and with the signature management system 228, which may be either internal to the first bank 212 (e.g., implemented as part of the servers 244a) or operated as an external signature management entity. Certain features of servers 244a may alternatively be performed as part of the signature management system 228.

The primary function of the signature management system 228 is to authenticate signatures. In support of this function, the signature management system 228 receives electronic signature data from electronic payment orders and stores the electronic signature data in the signature database 230. When called upon to authenticate an electronic signature on a new electronic payment order (e.g., through a request from the EPO front end server 240a), the signature management system 228 uses a signature comparison module 256 to compare the electronic signature data for a new electronic payment order. Based on the results of that comparison, a signature authentication module 258 makes a determination as to whether the signature is valid. For example, if the signature comparison module 256 determines that the electronic signature data for the new electronic payment order includes similar stroke pattern, stroke speed, pressure, and/or other potentially unique signature features, the signature authentication module 258 may determine that the electronic signature on the new electronic payment order is valid. On the other hand, sufficient differences (e.g. identified based on a heuristic analysis) may result in a rejection of the electronic signature and thus either a hold on the new electronic payment order or flagging the new electronic payment order for further review. For example, the signature management system 228 may communicate that the electronic signature is suspect to the one or more servers 244a via the EPO front end 240a, which may prevent the electronic payment order from being credited to a payee account and/or from being debited from a payor account.

The one or more servers 244a can perform a variety of functions. The servers 244a can be implemented as multiple coordinated servers or even as relatively segregated servers that perform isolated functions. The servers 244a may be geographically distributed and/or the functions of certain modules may be provided by external service providers. The servers 244a include, for example, an EPO web server 246, which may be used to provide a web page-based electronic payment order application to remote client devices (e.g., mobile devices 202 and 204) that the remote clients can use to generated electronic payment orders. In addition, the EPO web server 246 can be used to manage an authentication process for authenticating a user that is generating, depositing, or endorsing an electronic payment order and/or a device on which the user generates, deposits, or endorses the electronic payment order. For example, the EPO web server 246 may provide a login page that requires the user to provide a username and password to be able to generate an electronic payment order on the client device (using either a web page application or an application installed on the client device). In addition or as an alternative, the EPO web server 246 may require that the client device 202 provide identification or authentication information associated with the device itself (e.g., data stored in a cookie, data uniquely identifying the particular instance of the application loaded on the client, or data uniquely identifying the client device hardware) that allows the EPO web server 246 to confirm that the device is preregistered or preauthorized to generate electronic payment orders for the particular payor or payee. This user or device authentication information can be provided to a device and user authentication module 252 for use in authenticating the device and/or user. Finally, the EPO web server 246 may provide a web page that facilitates transmission of the electronic payment order from a payor client device to a payee.

The servers 244a also include posting systems 248 that are responsible for posting debits and credits to appropriate accounts based on received electronic payment orders. The debits and credits can be posted, for example, immediately upon receiving notice of an electronic payment order or at the end of the day. In some cases, the debits and credits may be immediately identified as pending transactions (e.g., so that the bank customer can see the pending activity online) even before the applicable debit or credit is applied to the account. In some cases, actual posting by the posting systems 248 can be dependent upon authorization by a payment authorization module 254, which may authorize payment (e.g., credit or debit) based on receiving an indication of a valid signature from the signature authentication module 258 of the signature management system 228. The payment authorization module 254 can also approve payment of funds based on whether the electronic payment order matches a notice received from the payor device 202 at the time the electronic payment order is generated and/or based on an explicit approval message received from the payor subsequent to initiating the electronic payment order (e.g., a retail positive pay feature). In addition, the payment authorization module 254 may determine if sufficient funds are available in a payor's account. If not, the payment authorization module 254 can send a message requesting that the payor authorize payment (and any applicable overdraft protection fees or other insufficient funds fees) and can await approval before authorizing the payment. If the payor does not authorize the fees, then the payment can be declined or canceled. If the payor simply does not respond in a sufficiently timely manner, the lack of response can be treated either as an implicit authorization or an implicit decline, depending on the particular implementation and/or the payor's preselected preferences or authorizations.

An image and electronic payment order exchange module 250 can be used to exchange (i.e., send and receive) both check images and electronic payment orders. Check images can be captured using the check imaging equipment 242 to create image exchange files that include images capable of being printed to produce a substitute check in compliance with Check Clearing for the 21st Century Act (“Check 21”). Electronic payment orders, on the other hand, cannot be printed to provide substitute checks that comply with Check 21, in the absence of regulatory changes that modify existing regulations to allow electronic payment orders to qualify as substitute checks. Check 21 requires, for example, that a substitute check be created based on an original paper check, which an electronic payment order as described herein does not include. Nonetheless, the electronic payment orders as described can be printed in much the same way as a substitute check (e.g., to provide a paper record, if desired, for the payor). Moreover, electronic payment orders can be exchanged using essentially the same check image exchange networks 220 that are used for exchanging images capable of being printed to produce substitute checks compliant with Check 21. Indeed, electronic payment orders can be included in files that are sent along with images for exchange (e.g., either as part of the same X9 file or files—for example, X9.100-187, which is the current standard, or its successor—or as a separate file). If separate, the electronic payment order files can be sent as part of the same transmission as an image exchange file or as a separate transmission. The files themselves, or the individual electronic payment orders, can include data (e.g., a field or flag in the electronic file) designating the electronic payment orders as electronic payment orders rather than check images. Moreover, even if the electronic payment orders are printed, the printed version can include some type of visual indicator (e.g., based on a designation included in the image) indicating that the item is an electronic payment order or otherwise arises from an electronic payment order. Such visual and/or electronic identifiers can allow the sending banks and receiving banks to separate out the electronic payment order from a combined check image processing stream, if necessary to apply special processing or unique customer rights to the electronic payment order.

In addition to providing authenticating users and devices, the device and user authentication module 252 can also confirm that the user has previously agreed to the requisite terms and conditions for electronic payment orders. Such terms and conditions can include the user's agreement that the electronic payment order is to be treated as a check such that the principles of traditional check law, including UCC Article 3, UCC Article 4, the federal Expedited Funds Availability Act (EFAA), Check 21, Regulation J of the Federal Reserve Board, and Regulation CC of the Federal Reserve Board, will govern the rights of the parties with respect to the electronic payment order processing and payment, and that the electronic signature will be treated as (or equivalent to) a payor's handwritten signature under such check laws. In addition, the device and user authentication module 252 can also confirm that the receiving bank and sending bank have agreed to appropriate terms and conditions or rules to govern the forward exchange and return of the electronic payment order. These interbank rules could include a requirement that the banks handling the electronic payment orders will only exchange electronic payment orders with other banks that have agreed to the applicable rules concerning exchange of electronic payment orders. These interbank rules may also establish warranties and indemnities appropriate to the handling the electronic payment orders. Such rules may further require the institutions or other entities involved in the exchange of an electronic payment order to not attempt to create a substitute check using the electronic payment order for either forward exchange or return or for delivery to a payor or payee. The interbank rules for processing electronic payment orders may also require that each sending bank warrant to all receiving banks that the electronic payment order accurately reflects all payment-related information included by prior persons or entities that generated or transferred the electronic payment order and that the collecting bank has not altered the payment-related information in a way that would affect processing and payment of the electronic payment order. In general, such customer agreements and interbank rules may be required between all parties involved in clearing the electronic payment order (e.g., between the payor and the payor bank, between the payor bank and the payee's bank or any intermediary collecting banks, among any intermediary collecting banks, between an intermediary collecting bank and the payee bank, and between the payee bank and the payee). In many cases, the agreements between the banks and their respective customers can be accomplished through standard deposit account agreements, and agreements between various different banks and other institutions can be accomplished through clearing house agreements (e.g., in accordance with rules promulgated by the Electronic Check Clearing House Organization) or other agreements governing check exchange.

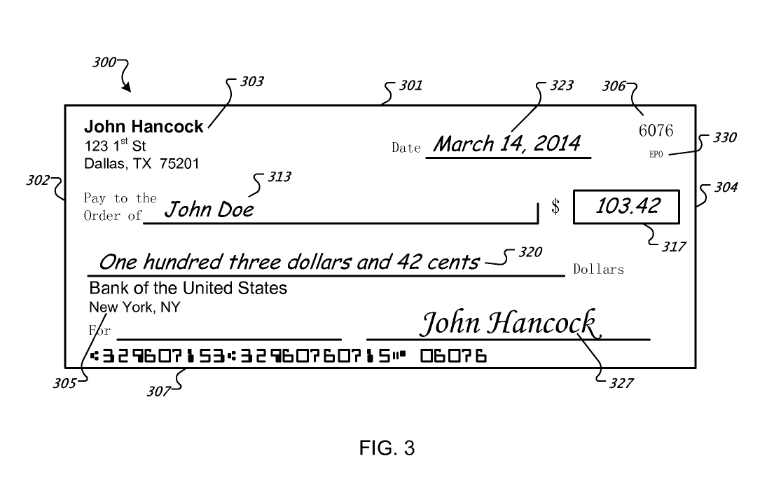

FIG. 3 is an example of the appearance of an electronic payment order 300. The electronic payment order 300 can include other hidden data in addition to an “image” component that provides a human-readable check-like document that can be printed if so desired. The electronic payment order 300 includes a top edge 301, a left edge 302 (e.g., the trailing edge on a conventional paper check), a right edge 304 (e.g., the leading edge on a conventional paper check), and a bottom edge 307 (e.g., the aligning edge on a conventional paper check) that can be selected such that the size of the electronic payment order 300 image is, for example, identical to or approximately the same as a conventional personal-size check or a conventional business-size check. The electronic payment order can include other features typically found on conventional checks, including a payor name and address 303, a payor bank 305, an item number 306, and a representation of a MICR line 307, all of which can be “preprinted” or predetermined for inclusion on the electronic payment order for a particular payor and particular electronic payment order for that payor. The MICR line 307 can comply with MICR standards (e.g., MICR E-13b) in the same location, font size, and format as required for paper checks, but without the use of magnetic ink. In addition, the electronic payment order can further include a payee name 313, a courtesy amount 317, a legal amount 320, a date 323, and a payor signature 327, all of which can be defined by the payor using an electronic payment order generation application (e.g., that provides an electronic payment order template) at the time of generating the electronic payment order (although the date can be defined automatically in some embodiments). The payor signature 327, as explained above, can be applied using a touch screen or other touch or movement sensitive pad or device. The signature 327 can be applied using the full dimensions of a touch screen or using a designated box on the touch screen and a resulting representation of the applied signature 327 can be placed in an appropriate location on the electronic payment order image 300. In addition to the features included on conventional checks, the electronic payment order also includes an indicator 330 that the item is an electronic payment order.

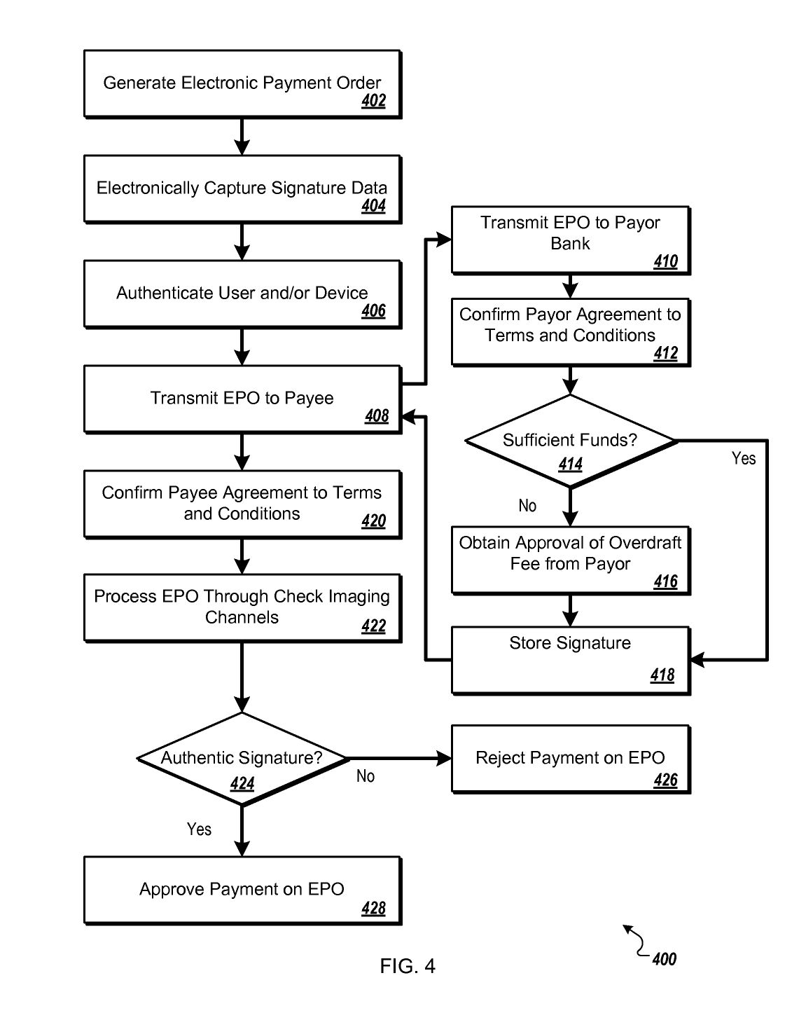

FIG. 4 is a flow diagram of a process 400 for generating and clearing an electronic payment order. The process 400 can be performed using the systems of FIGS. 1 and/or 2. Initially, an electronic payment order is generated at 402. Generation of the electronic payment order can include identifying a transaction sum or amount and a payee. Typically, this information is defined by the user using an electronic payment order application on a mobile device or other client device. Signature data for the electronic payment order is electronically captured approximately concurrently with the generation of the electronic payment order at 404. In particular, the signature data is generally captured dynamically based on the user's application of a signature on a touch screen or other motion sensitive device (e.g., an e-pen that automatically detects the motion and path of the pen), rather than using a pre-generated and pre-stored signature representation. The user that generates the electronic payment order and/or the device on which the electronic payment order is generated are authenticated at 406. The authentication can occur locally (e.g., on the device itself) and/or remotely (e.g., at a remote server associated with the user's bank) and can occur before or after the electronic payment order is generated.

Once the electronic payment order is complete, the user can initiate transmission of the electronic payment order to the payee (or someone designated by the payee to receive the electronic payment order) at 408. For example, the electronic payment order can be transmitted electronically (e.g., via electronic mail or over a personal area network) to the payee's device. Concurrently with sending the electronic payment order to the payee, the electronic payment order or an indication of the electronic payment order can be transmitted electronically to the user's (i.e., the payor's) bank at 410. The payor bank can confirm that the payor has previously agreed to terms and conditions required to be able to initiate electronic payment order payments at 412. A determination as to whether the user's account at the payor bank has sufficient funds is made at 414. If not, a message can be sent to the user requesting approval to pay on the electronic payment order along with payment of an overdraft fee, which the user can approve at 416. Without such approval, the electronic payment order may be canceled or put on hold. If the user approves or if there are sufficient funds in the user's account, the signature data can be stored at 418.

In parallel with the processing by the payor bank, although not necessarily at the same time, the payee bank can confirm that the payee has previously agreed to terms and conditions required to be able to deposit electronic payment orders with the payee bank for processing and collection at 420. The electronic payment order can then be processed through check imaging channels at 422. This processing can include posting, verifying the authenticity of the item (e.g., fraud detection), storing a copy of the item, and generating and sending a file for electronic exchange with the payor bank or an intermediary institution. This processing can also include returns and adjustments, if necessary. A determination is made as to whether the electronic signature for the electronic payment order is authentic at 424. This determination can be made based on a comparison of the electronic signature with other electronic signatures provided by the payor on prior electronic payment orders to ensure that the signature is made by the same individual. This determination can be made at one or more points during the process 400, and can be done by or for multiple different entities (e.g., payee, payee's bank, intermediary banks, and/or payor bank). If the signature is authentic, payment on the electronic payment order can be approved at 428. Otherwise, payment or posting based on the electronic payment order can be rejected at 426.

An electronic payment order may correspond to or be a part of an electronic document. An electronic document (which for brevity will simply be referred to as a document) may, but need not, correspond to a file. A document may be stored in a portion of a file that holds other documents (e.g., as part of a larger file), in a single file dedicated to the document in question, in multiple coordinated files (e.g., as separate data and image files), or as some other assembly of data.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. In some embodiments, instead of generating and signing an electronic payment order electronically, it is possible for a payor to use a pre-printed check or a printed version of an electronically created check that is signed in a conventional manner (e.g., using a pen) and then imaged by the payor (or on behalf of the payor). The payor could then electronically transmit the image (and possibly payment data included in data fields that accompany the image) to the payee. Such an image may not qualify as a check under existing regulations because the paper check is not received by the payee, but the techniques described in this specification could be used to process the payment order.

What is claimed is:

1. A method performed by data processing apparatus, the method comprising:
generating, by operation of a computer, an electronic payment order;
electronically capturing signature data authorizing the electronic payment order, wherein the signature data includes a stroke pattern of a user signature and is captured substantially concurrently with generating the electronic payment order; and
transmitting the electronic payment order and the electronically captured signature to an entity authorized to receive payment based on the electronic payment order.

2. The method of claim 1 wherein the electronic payment order is generated on a mobile device by a user and the stroke pattern is electronically captured using a touch screen or a digital pad that detects contact with a pad surface.

3. The method of claim 2 wherein the electronic payment order is generated using one of an application stored on the mobile device or an electronic document retrieved from a web server.

4. The method of claim 3 further comprising:
authenticating the mobile device based on a prior registration of the mobile device with a server; and
authenticating the user based on credentials provided by the user.

5. The method of claim 4 further comprising:
confirming that the user has agreed to terms and conditions associated with a service that allows the user to generate electronic payment orders; and
confirming that a payee identified in the electronic payment order has agreed to terms and conditions associated with a service that allows the payee to receive electronic payment orders from the payor and deposit electronic payment orders with the payee bank for processing and collection.

6. The method of claim 3 further comprising transmitting a notice of the generation of the electronic payment order to a financial institution having a payor account on which the electronic payment order is drawn.

7. The method of claim 6 further comprising receiving, at an electronic device associated with the payor, a request to approve payment of the electronic payment order, wherein the request is generated in response to the notice.

8. The method of claim 7 wherein the request to approve payment further includes a request to approve a charge for insufficient funds in the payor account for payment of the electronic payment order.

9. The method of claim 1 further comprising encrypting the electronically captured signature data.

10. The method of claim 1, wherein generation of the electronic payment order is initiated by a payor having a payor account with a first financial institution, the electronic payment order is drawn on the payor account, and the electronic payment order includes an order to pay specified funds to a payee, the method further comprising sending the electronic payment order through a check image exchange channel from a second financial institution authorized to collect the funds on behalf of the payee.

11. The method of claim 10 wherein agreements that the electronic payment order is to be treated as a negotiable instrument are in place between:
the payor and the first financial institution;
the first financial institution and the second financial institution; and
the payee and the second financial institution.

12. The method of claim 10 wherein the electronic payment order includes data distinguishing the electronic payment order from a check image at least when the electronic payment order is sent through the check image exchange channel.

13. The method of claim 12 wherein the check image exchange channel is used to exchange images that can be printed to produce substitute checks compliant with the Check Clearing for the 21^{st} Century Act and the electronic payment order is not eligible to be printed as a substitute check.

14. The method of claim 13 wherein the check image exchange channel includes:
one or more computers associated with the second financial institution adapted to send electronic files including check images to at least one of an intermediary or the first financial institution across a network; and
one or more computers associated with the first financial institution adapted to receive electronic files including check images from at least one of an intermediary or the second financial institution across a network.

15. A computer storage medium encoded with a computer program, the program comprising instructions that when executed by data processing apparatus cause the data processing apparatus to perform operations including:
generating an electronic payment order;
electronically capturing signature data authorizing the electronic payment order, wherein the signature data includes a stroke pattern of a user signature captured substantially concurrently with generating the electronic payment order; and
transmitting the electronic payment order and the electronically captured signature to an entity authorized to receive payment based on the electronic payment order.

16. The medium of claim 15 wherein the program further comprises instructions that when executed by data processing apparatus cause the data processing apparatus to perform operations including generating the signature data based on signals received from one of a touch screen or a digital pad that detects contact with a pad surface.

17. The medium of claim 15 wherein the program further comprises instructions that when executed by data processing apparatus cause the data processing apparatus to perform operations including:
sending authentication data associated with hardware of the mobile device to a server;
receiving credentials from a user prior to generating the electronic payment order; and
authenticating the user based on the credentials provided by the user or the credentials sent to the server.

18. The medium of claim 15 wherein the program further comprises instructions that when executed by data processing apparatus cause the data processing apparatus to perform operations including transmitting a notice of generation of the electronic payment order to a server associated with a financial institution having a payor account on which the electronic payment order is drawn.

19. The medium of claim 18 wherein the program further comprises instructions that when executed by data processing apparatus cause the data processing apparatus to perform operations including receiving a request to approve payment of the electronic payment order, wherein the request is generated in response to the notice and the request to approve payment further includes a request to approve a charge for insufficient funds in the payor account for payment of the electronic payment order.

20. The medium of claim 15 wherein the program further comprises instructions that when executed by data processing apparatus cause the data processing apparatus to perform operations including sending a request to authenticate the electronic payment order to a server, wherein the request to authenticate includes at least one of a password associated with the user or predetermined authentication information associated with the data processing apparatus.

21. A system comprising:
one or more storage devices storing signature data from electronic signatures applied to electronic payment orders;
one or more processors operable to:
receive signature data from an electronic signature applied by a user to a particular electronic payment order to authorize payment of the particular electronic payment order from a particular payor account, wherein the particular electronic payment order is generated on a mobile device and is electronically captured, and the signature data includes a stroke pattern for the electronic signature captured substantially concurrently with generating the particular electronic payment order;
store the received signature data in the one or more storage devices; and
compare the received signature data to signature data previously stored in the one or more storage devices to authenticate the received signature data.

22. The system of claim 21 further comprising at least one server for a payor institution that maintains the payor account, wherein the at least one server is operable to receive the particular electronic payment order from at least one of a mobile device on which the particular electronic payment order is generated or a payee institution authorized to collect funds based on the electronic payment order.

23. The system of claim 22 wherein the one or more processors are operable to determine whether to authorize payment of the funds based on the comparison of the received signature data to the previously stored signature data.

24. The system of claim 23 wherein the at least one server is operable to receive, from payee institutions, electronic payment orders transmitted across a check image exchange channel used to exchange images that can be printed to produce substitute checks compliant with the Check Clearing for the 21st Century Act, and the electronic payment order is not eligible to be printed as a substitute check.

25. The system of claim 24 wherein the electronic payment order includes data distinguishing the electronic payment order from a check image.

26. The system of claim 23 wherein the at least one server is further operable to:
authenticate the mobile device based on a prior registration of the mobile device with the one or more processors; and
authenticate the user based on credentials provided by the user.

27. The system of claim 26 wherein the one or more processors are further operable to transmit a request to approve a charge for insufficient funds in the payor account for payment of the particular electronic payment order.

28. The system of claim 23 wherein the one or more processors are operable to:
confirm that the user has agreed to terms and conditions associated with a service that allows the user to generate electronic payment orders; and
confirm that a payee identified in the electronic payment order has agreed to terms and conditions associated with a service that allows the payee to receive electronic payment orders.
